(19) United States
(12) Patent Application Publication
(10) Pub. No.: US 2024/0228047 A1
(43) Pub. Date: Jul. 11, 2024

(54) DYNAMIC PARACHUTE REEFING SYSTEM FOR AIRCRAFT MODULE

(71) Applicant: Vivek Sandrapaty, Ocala, FL (US)

(72) Inventor: Vivek Sandrapaty, Ocala, FL (US)

(21) Appl. No.: 18/430,336

(22) Filed: Feb. 1, 2024

Related U.S. Application Data
(63) Continuation-in-part of application No. 18/405,802, filed on Jan. 5, 2024, now abandoned.
(60) Provisional application No. 63/437,230, filed on Jan. 5, 2023.

(51) Int. Cl. B64D 17/34; B64D 25/12

(52) U.S. Cl. CPC B64D 17/343; B64D 25/12

(57) ABSTRACT

A separable aircraft cabin module is provided with parachutes that are dynamically and independently reefed in order to safely deliver the cabin module, and its occupants from a separation from a main aircraft body at altitude and speed to a landing. The arrangement includes a rear parachute and two front parachutes which particularly handle the cylindrical shape of the cabin module through the various stages after separation from the main aircraft body.

### CROSS REFERENCE

This application claims the benefit U.S. patent application Ser. No. 18/405,802 which was filed on Jan. 5, 2024, and which claimed the benefit of provisional application No. 63/437,230 filed Jan. 5, 2023, the entireties of each of which are hereby incorporated by reference.

### FIELD OF THE INVENTION

The present invention relates generally to aircraft, and, more particularly, relates to a dynamic parachute reefing system for use with an aircraft cabin module that can separate from a main body of the aircraft that ensures safe landing of the cabin module after separating from the main body of the aircraft.

### BACKGROUND OF THE INVENTION

Parachutes have been used in light aircraft as a safety backup in case of severe damage to the aircraft or due to loss of engine power. These aircraft tend to be single engine propeller driven and do not have pressurized cabins. As such, they fly at generally lower altitude and at slower speed than larger, commercial aircraft. Accordingly, while a parachute is usable for a small aircraft traveling at a relatively low speed, the same sort of parachute is not useable on a large commercial aircraft traveling at double or triple the speed of small light aircraft. To survive an opening at a normal cruising speed of a commercial aircraft, the parachute would either be so small that it could not provide sufficient slowing drag after deploying to achieve safe landing, or the cabling and parachute so strong that upon opening, the resulting sudden deceleration would be unsafe for passengers.

Therefore, a need exists to overcome the problems with the prior art as discussed above.

### SUMMARY

In accordance with some embodiments of the inventive disclosure, there is provided a dynamic parachute reefing system for a separable aircraft cabin module in which the aircraft cabin module has a cylindrical shape. The parachute reefing system includes two parachutes disposed at a forward end of the cabin module and at least one parachute disposed at a rear of the cabin module. Each of the parachutes includes reef lines that are each controlled by respective reefing motor. There is a controller that is configured to control the reefing motors to dynamically control a reef state of each one of the parachutes upon deployment after separation of the cabin module from an aircraft main body, and to control deceleration of the cabin module, a decent speed of the cabin module, and a landing of the cabin module, while preventing undue roll, pitch or yaw of the cabin module.

In accordance with a further feature, there is additionally included a steering motor for steering the at least one parachute disposed at the rear of the cabin module, and wherein the at least one parachute disposed at the rear of the cabin module is steerable.

In accordance with a further feature, each of the two parachutes disposed at the forward end of the cabin module and the at least one parachute disposed at the rear of the cabin module comprise a canopy connected to a plurality of suspension lines which are attached to the cabin module and which pass through a reefing ring whose position along the suspension lines is controlled by a respective reefing motor.

In accordance with a further feature, each of the respective reefing motors controls reefing of its respective parachute by maintaining a maximum reef state during a deceleration stage, an intermediate reef state during a descent stage, and a minimal reef state during a landing stage.

In accordance with some embodiments of the inventive disclosure, there is provided a separable cabin module for an aircraft that includes a cylindrical body having a front end and a rear end. There is a rear parachute initially stored and connected to the rear end, and a first front parachute and a second front parachute that are each initially stored and connected to the front end. Each of the rear parachute, first front parachute, and second front parachute include a reefing ring. There is a rear reefing motor at the rear end that is coupled by a rear reefing line to the reefing ring of the rear parachute, a first front reefing motor at the front end that is coupled by a first front reefing line to the reefing ring of the first front parachute, and a second front reefing motor at the front end that is coupled by a second front reefing line to the reefing ring of the second front parachute. There is further included a controller the receives input regarding at least an altitude of the cabin module, a velocity of the cabin module, and pitch, roll, and yaw of the cabin module, and which in response controls each of the rear reefing motor, first front reefing motor, and second reefing motor to independently and dynamically control a reef state of each of the rear parachute, first front parachute, and rear parachute in response to the altitude, velocity, pitch, roll, and yaw of the cabin module through deceleration, descent, and landing stages.

In accordance with a further feature, the rear parachute is steerable.

In accordance with a further feature, the controller further controls a steering motor coupled to the rear parachute.

In accordance with a further feature, the input indicating velocity indicates the velocity in three dimensions.

In accordance with a further feature, the cabin module is pressurized.

In accordance with a further feature, the reefing rings for each of the rear, first front, and second front parachutes are bi-directional.

In accordance with some embodiments of the inventive disclosure, there is provided an aircraft that includes a main aircraft body and a cabin module separably disposed in the main aircraft body having a front end and a rear end. The cabin module includes a rear parachute initially stored and connected to the rear end, and a first front parachute and a second front parachute that are each initially stored and connected to the front end. Each of the rear parachute, first front parachute, and second front parachute include a reefing ring. There is also a rear reefing motor at the rear end that is coupled by a rear reefing line to the reefing ring of the rear parachute, a first front reefing motor at the front end that is coupled by a first front reefing line to the reefing ring of the first front parachute, and a second front reefing motor at the front end that is coupled by a second front reefing line to the reefing ring of the second front parachute. There is also a controller the receives input regarding at least an altitude of the cabin module, a velocity of the cabin module, and pitch, roll, and yaw of the cabin module, and which in response controls each of the rear reefing motor, first front reefing motor, and second reefing motor to independently and dynamically control a reef state of each of the rear parachute, first front parachute, and rear parachute in response to the altitude, velocity, pitch, roll, and yaw of the cabin module through deceleration, descent, and landing stages.

In accordance with a further feature, the rear parachute is steerable.

In accordance with a further feature, the controller further controls a steering motor coupled to the rear parachute.

In accordance with a further feature, the input indicating velocity indicates the velocity in three dimensions.

In accordance with a further feature, the cabin module is pressurized.

In accordance with a further feature, the reefing rings for each of the rear, first front, and second front parachutes are bi-directional.

Although the invention is illustrated and described herein as embodied in a dynamic parachute reefing system for a separable aircraft cabin module, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. To the extent that the inventive disclosure relies on or uses software or computer implemented embodiments, the terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the embodiments of the present invention according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 shows an aircraft have a separable cabin module with the cabin module in place in the main aircraft body.

FIG. 2A shows an aircraft have a separable cabin module with the cabin module separated from the main aircraft body.

FIG. 2B show and end elevational view of a cabin module, in accordance with some embodiments.

FIG. 3A shows the cabin module after separation from the main aircraft body during a deceleration stage, in accordance with some embodiments.

FIG. 3B shows the cabin module after separation from the main aircraft body during a descent stage, in accordance with some embodiments.

FIG. 3C shows the cabin module after separation from the main aircraft body during a landing stage, in accordance with some embodiments.

FIG. 4A shows a side view of a reefing ring with the suspension lines in place through guides, in accordance with some embodiments.

FIG. 4B shows the reefing ring of FIG. 4A without the suspension lines so that the bridle can be seen.

FIG. 4C shows a bidirectional reefing ring that allows reefing of a parachute after it has been opened in order to adjust reefing as needed, in accordance with some embodiments.

FIG. 5 shows a block schematic diagram of a dynamic parachute reefing system for a cabin module, in accordance with some embodiments.

FIG. 6 shows a stage diagram of the various stages of delivering a cabin module from an aircraft main body at altitude to landing.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The disclosed inventive embodiments provide a novel aircraft configuration that allows for the safe delivery of the main aircraft cabin module from the main aircraft body to a landing. The cabin module is separable from the main aircraft body so that, in the event of an emergency with the aircraft, the occupants can separate from the main aircraft body in the cabin module and land safely. The cabin module includes a rear parachute and two front parachutes that can be adjustably reefed during deceleration, descent, and landing stages. A control system processes inputs such as altitude, velocity, pitch, roll, yaw of the cabin module and adjusts reefing during descent to reduce the risk of injury to the occupants.

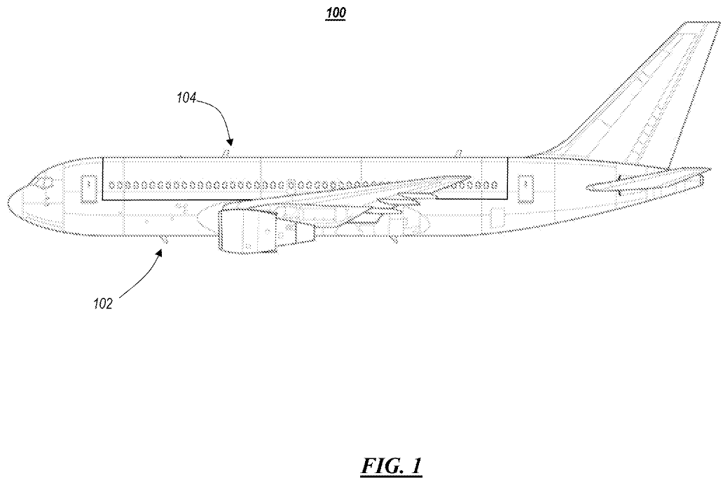

FIG. 1 shows an aircraft 100 having a separable cabin module 104 with the cabin module in place in the main aircraft body 102. A cabin module that can separate from the main body of an aircraft has been thought of for easily moving passengers from one aircraft to another, or for quickly changing to a clean cabin module rather than holding aircraft at a terminal gate for cleaning. The cabin module 104 must be sealed so that it can be pressurized at altitude. In accordance with present invention, the cabin module 104 is also configured to be separable from the main aircraft body at cruising altitude, if necessary, and at cruising speed or a substantial proportion of the cruising speed. Because this could be a rather violent event, the separation occurs in a particular order to reduce the likelihood of injury to passengers in the cabin module 104.

Upon separation of the cabin module 104 from the main body 102, there will be a number of forces acting upon the cabin module which can induce undesirable rotation of the cabin module 104 in yaw, pitch, and roll dimensions. Therefore, these forces must be counteracted before they result in an unrecoverable motion, and before causing undue risk to the occupants of the cabin module. In addition, the velocity of the cabin module, both with respect to the ground and the air, must be reduced to a level that provides for a safe landing of the cabin module 104.

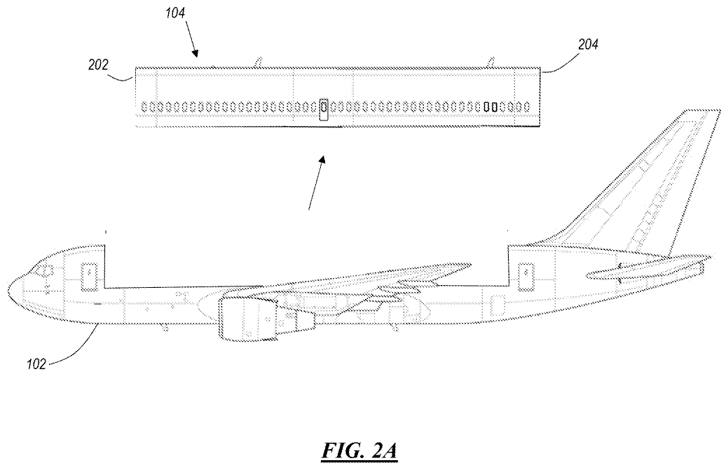

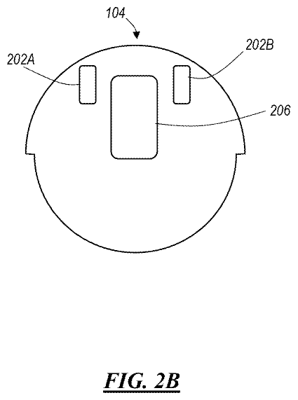

In FIG. 2A the cabin module 104 is shown separated from the main aircraft body 102, however the angle and attitude of the cabin module 104 relative to the aircraft body 102 shown here are not necessarily indicative of how a separation would actually occur. Rather, the illustration of FIG. 2A is meant to emphasize what is meant by a separable cabin module 104. The cabin module 104 comprises forward parachutes 202A, 202B and a rear parachute 204. Each of the parachutes 202A, 202B, 204 comprise a parachute canopy and reefing lines that can be deployed, and the inflation of each parachute 202A, 202B, 204 is controlled by independent dynamic reefing. For example, upon initial deployment of the parachutes, the cabin module may be traveling at a high velocity in the air; to slow the cabin module, the parachutes can be deployed such that their canopies are heavily reefed, preventing the canopies from opening much, and maintain them in a mostly-closed state. The drag created by the closed canopies will slow the cabin module in the air. The reefing is controlled so that the deceleration from cruising speed is controlled so as not to unduly risk injury to the occupants of the cabin module 104. The parachutes can be allowed to inflate more over time after the initial deceleration to a minimum horizontal speed, as allowed by winds relative to the ground. FIG. 2B shows an elevational view of the front end of the cabin module 104. As can be seen the cabin module 104 has a substantially cylindrical shape, and having an elongated direction along the fuselage of the aircraft. There is a door 206 that is open when boarding and disembarkment, but is closed and forms a seal to prevent loss of cabin pressure in the event of a mid-flight cabin module separation event. The fact that the cabin module 104 is cylindrically shaped is an important consideration in the arrangement of the parachutes 202A, 202B, 204.

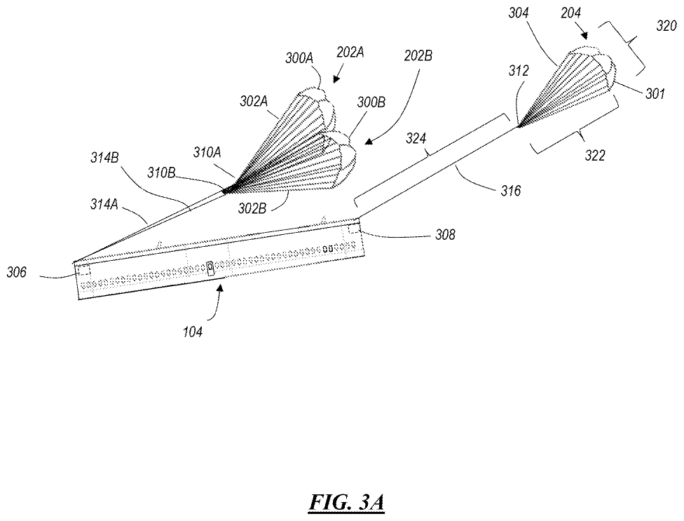

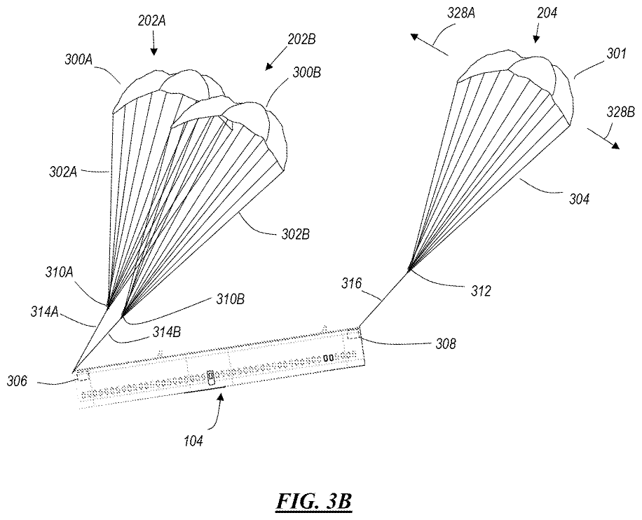

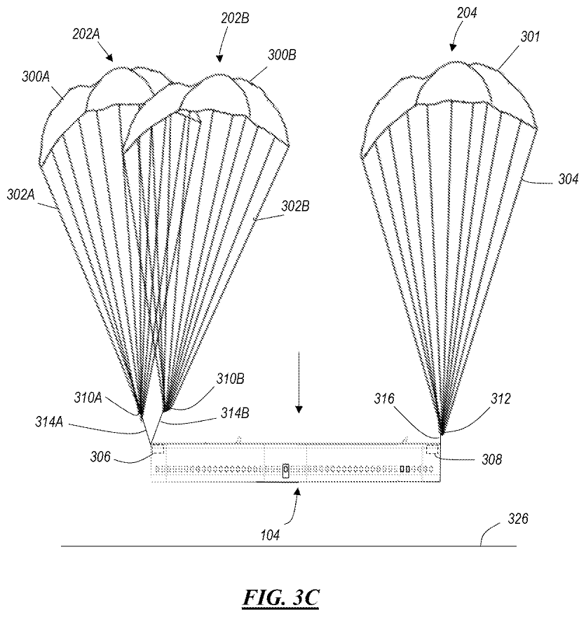

FIGS. 3A, 3B, and 3C show the cabin module 104 after deployment of dynamically reefable parachutes to control the deceleration, decent speed, and roll, pitch, and yaw of the cabin module as it descends from an initial separation stage in FIG. 3A, to an intermediate controlled decent stage in FIG. 3B, and finally to a landing stage in FIG. 3C. In order to prevent rotation of the cabin module 104, two parachutes 202A, 202B are deployed from the front of the cabin module 104. One parachute 204 is provided in the rear of the cabin module 104 to keep the cabin module 104 relatively level. Each parachute 202A, 202B, 204 has a respective canopy 300A, 300B, 301, and associated suspension lines 302A, 302B, 304. The suspension lines 302A, 302B, 304 are connected to edge points around their respective canopies 300A, 300B, 301, and to the respective ends of the cabin module 104, and the suspension lines 302A, 302B, 304 are gathered together along their length at various reef points 310A, 310B, 312 where a reef ring is located. Reefing lines 314A, 314B, 316 pass through the suspension lines 302A, 302B, 304 and are connected to the reefing ring at the reefing point 310A, 310B, 312, and to reefing motors 306, 308. Reefing motors 306, 308 are dynamically controlled to reef the canopies by an appropriate amount to achieve, deceleration, decent, and then landing, while at the same time preventing excessive roll, pitch, or yaw of the cabin module after it is separated from the aircraft. The reef state of each parachute 202A, 202B, 204 is controlled in response to various factors, including the three space velocities of the cabin module 104, as well as any pitch, roll, and yaw that may be occurring. All of these parameters, as well as altitude over land, are inputs to the control loop of the reefing motors 306, 308 in order to traverse through the various stages of decent.

The reefing controls the canopy width 320 of each parachute by adjusting the reef point 310A, 310B, 312 along the suspension lines 302A, 302B, 304. The suspension lines 302A, 302B, 314 thus have a free length 322 between the canopy 300A, 300B, 301 and the reef point 310A, 310B, 312, and a reefed length 324 between the reef point 310A, 310B, 312 and the respective reef motors 306, 308. It should be noted that reefing motor 306 shown here in FIGS. 3A-3C is actually two reefing motors (e.g., 306A, 306B) as the reefing of each parachute is dynamically and independently adjusted during decent. In FIG. 3A, which is the initial deceleration stage, the canopy width 320 will be at its smallest, starting out with maximum reefing. The reef points 310A, 310B, 312 are shown here in FIG. 3A at about two thirds of the way along the suspension lines 302A, 302B, 304, but can be right at the canopy edges at initial deployment of the parachutes. As the cabin module decelerates, the reefing lines 314A, 314B, 316 are used to move the reefing points 310A, 310B, 312 closer to the cabin module 104 along the suspension lines 302A, 302B, 304 to allow the canopies 300A, 300B, 301 to open wider, resulting in further deceleration until a decent stage is reached in FIG. 3B. In the decent stage the cabin module is descending at a safe rate, but generally at a rate that would be considered too fast for landing. The intent is to allow to cabin module 104 to descend as quickly as possible, safely, to an elevation over ground where the landing stage begins. Thus, the duration and descent velocity during the descent stage depends on the cabin module altitude after the deceleration stage. It is contemplated that at least the rear parachute 204 can be steerable, so that the rear end of the cabin module 104 can be directed to either side, as indicated by arrows 328A, 328B to oppose any tendency of the cabin module to yaw in response to wind or other atmospheric anomaly. In the landing stage, as represented in FIG. 3C, the reefing points 310A, 310B, 312 can be pulled in closest to the cabin module 104 by the respective reefing motors 306, 308 to allow a safe landing on ground 326. During all stages of FIGS. 3A-3C the reefing of each parachute is dynamically and independently controlled, and response to any wind events or atmospheric anomalies that may be encountered during the descent that may otherwise cause the cabin module to rotate (yaw, pitch, roll) excessively. It is further noted that, since the cabin module is cylindrically shaped, there can be horizontal beams on the bottom of the cabin module 104 that rotate outward in the landing stage to prevent the cabin module from rolling upon contact with the ground 326.

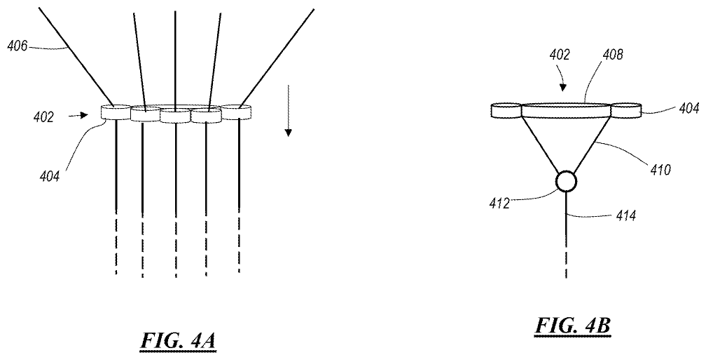

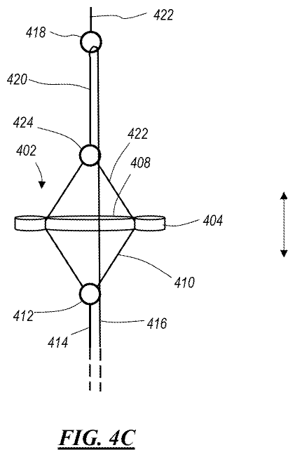

FIG. 4A shows a reefing ring 402 with the suspension lines 406 passing through guides 404. The reefing ring 402 can be generally shaped in the shape of the open canopy to which the suspension lines 406 are attached. The suspension lines 406 are attached between the corners/edges of the parachute canopy and the cabin module. The reefing ring 402 can be moved along the suspension lines 406 to adjust the amount that the canopy can open. When the reefing ring 402 is closest to the canopy, the canopy will only open to a minimum size. When the reefing ring 402 is moved all the way to the cabin module, the canopy will be able to open to its maximum size. A center line can be used to pull in the center of the canopy to increase its open diameter/area, as is known. In FIG. 4B, the suspension lines 406 have been removed and the inner ring 408 can be seen, to which there guides 404 are attached. A bridle 401 and bridle ring 412 are attached to the inner ring 408. The bridle ring 412 is further attached to a reefing line 414 that is connected to a reefing motor in the cabin module. Thus, the suspension lines 406 run through guides 404 on the outside of the inner ring 408, and the reefing motor can move the reefing ring 402 along the suspension lines 406 to control the reef state of the canopy. In FIG. 4C a reefing arrangement is shown in which the reefing ring 402 can be moved in both directions in the event that a canopy needs to be reefed more in response to weather or atmospheric turbulence/anomalies. A second reefing line 416 is connected (at its lower end) the reefing motor. The second line 416 can be a continuation of the first line 414 so that as one is drawn to the motor, the other is let out. The second line 416 passes through the reefing ring 402 to a pulley or guide 418 that is attached to, for example, the center of the canopy by line 422 (or directly). The end 420 of the second line 416 traverses back from the guide 418 to a second bridle 422 and bridle ring 424. This arrangement allows the reefing ring 402 to be moved up and down along the suspension lines to adjust the reef state of the canopy. It also allows the center of the canopy to be pulled in to maximize the area of the canopy and produce maximum drag, which can be used for touchdown at the end of the landing stage.

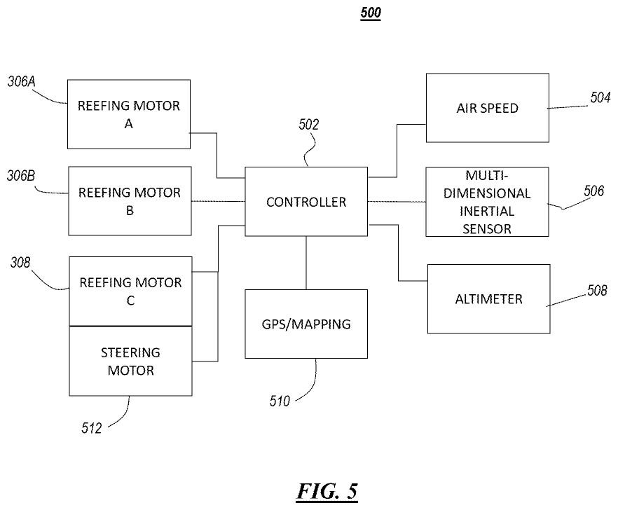

FIG. 5 shows a block schematic diagram of a dynamic parachute reefing system 500 for a cabin module. A controller 502 includes one or more microprocessors, memory, and instruction code to carry out the dynamic reefing function. Certain inputs are provided to the controller 502, such as air speed of the cabin 504, an inertial sensor 506 that indicates the direction of gravity as well as the movement of the cabin module relative to the direction of gravity, which indicates pitch, roll, and yaw of the cabin module. There is also an altimeter 508 that indicates the altitude of the cabin module. In addition, other inputs can be used, such as, for example, a geolocation as indicated by a Global Positioning System (GPS) receiver and topographic maps 510 that can indicate elevation over ground and identify potential landing areas. These inputs are used by the controller to dynamically control each of several reefing motors or servos 306A, 306B, 308, which correspond to parachutes 202A, 202B, and 204. Further a steering motor or motors 512 can steer the rear parachute. The front parachutes in some embodiments can also be steerable. The controller 502 can use a trained artificial intelligence engine to take in all the inputs and decide the appropriate reef state for each parachute 202A, 202B, and 204 to progress through deceleration, descent, and landing stages to achieve the safest landing possible. Different engines can be used for each of the deceleration, descent, and landing stages.

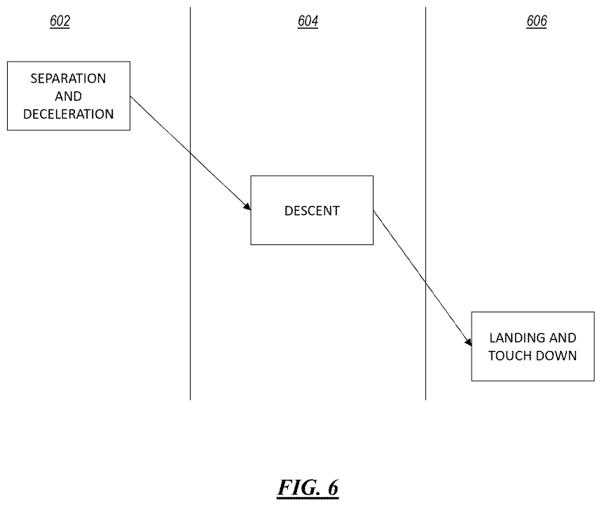

FIG. 6 shows a progression of stages that roughly correspond to FIGS. 3A-3C. In a separation and deceleration stage 602, it has been determined that there is an unresolvable issue with the aircraft that requires separation of the cabin module from the main aircraft body, and that the aircraft is at sufficient altitude to achieve a safe separation. The cabin module is sealed to maintain pressurization, but oxygen masks may be deployed in case of a breach of the cabin module. A mechanical separation occurs, pushing the cabin module out of the main aircraft body. The rear parachute, fully reefed, may be deployed initially to both decelerate the cabin module and keep it from unduly pitching or yawing, as well as ensure that it is clear of the main aircraft body. Shortly thereafter, on the order of seconds or less, the front two parachutes may be deployed, also fully reefed, to further decelerate the cabin module. The three parachutes, with two in the front and one at the rear, have been found to best control a cylindrical cabin module through this stage 602, as well as the other stage 604, 606. Once the cabin module has decelerated to a preselected velocity, then reefing of the parachutes is adjusted for the descent stage 604. The goal of the descent stage is to safely, and quickly, descend from the separation altitude to a landing altitude, and to prevent undue motion of the cabin module that could result in injury of the occupants. Thus, the reefing of each parachute is independently controlled in response to any wind events or other atmospheric anomalies that may be encountered during decent. Further, it is contemplated that at least the rear parachute can be steerable in order to counteract any tendency of the cabin module to excessively yaw (flat spin). Once the cabin module is within a preselected altitude over ground (or water), then the landing stage 606 is entered. In the landing stage 606, the parachutes can be opened further to slow the descent of the cabin module to a safe landing speed. If there is wind, then the rear parachute can be steered to align the longitudinal axis of the cabin module with the direction of the wind to prevent side forces being imparted to the cabin module upon contact. At the end of the landing stage is the touchdown where the parachutes are maximally opened, which may include pulling in the center of each parachute to open the canopies to their maximum spread.

Accordingly, the disclosed inventive embodiments provide the benefit of a separable cabin module for an aircraft that can deliver the occupants of the aircraft to a landing safely after separating from the main aircraft body. It has been found that, given that the cabin module is substantially cylindrical, an arrangement of one parachute at the rear of the cabin module, and two parachutes at the front of the cabin module, along with dynamic and independent reef control of each parachute canopy, can safely deliver a cabin module from separation at altitude and cruising speed to a safe landing. Background math and other discussion can be found in the appendix filed with the provisional application to which this application claims priority in the “CROSS REFERENCE” section herein, the disclosure of which is, again, hereby incorporated by reference.

What is claimed is:

1. A dynamic parachute reefing system for a separable aircraft cabin module, the aircraft cabin module having a cylindrical shape, comprising:
two parachutes disposed at a forward end of the cabin module and at least one parachute disposed at a rear of the cabin module;
each of the parachutes including reef lines that are each controlled by respective reefing motor;
a controller that is configured to control the reefing motors to dynamically control a reef state of each one of the parachutes upon deployment after separation of the cabin module from an aircraft main body, to control deceleration of the cabin module, a decent speed of the cabin module, and a landing of the cabin module.

2. The dynamic parachute reefing system of claim 1, further comprising a steering motor for steering the at least one parachute disposed at the rear of the cabin module, and wherein the at least one parachute disposed at the rear of the cabin module is steerable.

3. The dynamic parachute reefing system of claim 1, wherein each of the two parachutes disposed at the forward end of the cabin module and the at least one parachute disposed at the rear of the cabin module comprise a canopy connected to a plurality of suspension lines which are attached to the cabin module and which pass through a reefing ring whose position along the suspension lines is controlled by a respective reefing motor.

4. The dynamic parachute reefing system of claim 3, wherein each of the respective reefing motors controls reefing of its respective parachute by maintaining a maximum reef state during a deceleration stage, an intermediate reef state during a descent stage, and a minimal reef state during a landing stage.

5. A separable cabin module for an aircraft, comprising:
a cylindrical body having a front end and a rear end;
a rear parachute initially stored and connected to the rear end, and a first front parachute and a second front parachute that are each initially stored and connected to the front end;
each of the rear parachute, first front parachute, and second front parachute including a reefing ring;
a rear reefing motor at the rear end that is coupled by a rear reefing line to the reefing ring of the rear parachute;
a first front reefing motor at the front end that is coupled by a first front reefing line to the reefing ring of the first front parachute;
a second front reefing motor at the front end that is coupled by a second front reefing line to the reefing ring of the second front parachute; and
a controller the receives input regarding at least an altitude of the cabin module, a velocity of the cabin module, and pitch, roll, and yaw of the cabin module, and which in response controls each of the rear reefing motor, first front reefing motor, and second reefing motor to independently and dynamically control a reef state of each of the rear parachute, first front parachute, and rear parachute in response to the altitude, velocity, pitch, roll, and yaw of the cabin module through deceleration, descent, and landing stages.

6. The separable cabin module of claim 5, wherein the rear parachute is steerable.

7. The separable cabin module of claim 6, wherein the controller further controls a steering motor coupled to the rear parachute.

8. The separable cabin module of claim 6, wherein the input indicating velocity indicates the velocity in three dimensions.

9. The separable cabin module of claim 5, wherein the cabin module is pressurized.

10. The separable cabin module of claim 5, wherein the reefing rings for each of the rear, first front, and second front parachutes are bi-directional.

11. An aircraft, comprising:
a main aircraft body;
a cabin module separably disposed in the main aircraft body having a front end and a rear end and including:
a rear parachute initially stored and connected to the rear end, and a first front parachute and a second front parachute that are each initially stored and connected to the front end;
each of the rear parachute, first front parachute, and second front parachute including a reefing ring;
a rear reefing motor at the rear end that is coupled by a rear reefing line to the reefing ring of the rear parachute;
a first front reefing motor at the front end that is coupled by a first front reefing line to the reefing ring of the first front parachute;
a second front reefing motor at the front end that is coupled by a second front reefing line to the reefing ring of the second front parachute; and
a controller the receives input regarding at least an altitude of the cabin module, a velocity of the cabin module, and pitch, roll, and yaw of the cabin module, and which in response controls each of the rear reefing motor, first front reefing motor, and second reefing motor to independently and dynamically control a reef state of each of the rear parachute, first front parachute, and rear parachute in response to the altitude, velocity, pitch, roll, and yaw of the cabin module through deceleration, descent, and landing stages.

12. The aircraft of claim 11, wherein the rear parachute is steerable.

13. The aircraft of claim 12, wherein the controller further controls a steering motor coupled to the rear parachute.

14. The aircraft of claim 12, wherein the input indicating velocity indicates the velocity in three dimensions.

15. The aircraft of claim 11, wherein the cabin module is pressurized.

16. The aircraft of claim 11, wherein the reefing rings for each of the rear, first front, and second front parachutes are bi-directional.
